(19) United States
(12) Patent Application Publication
(10) Pub. No.: US 2007/0154011 A1
(43) Pub. Date: Jul. 5, 2007

(54) POWER LINE COMMUNICATION-ENABLED HOME TERMINAL, METHOD FOR AUTOMATICALLY SETTING THE SAME, AND PROGRAM AND RECORDING MEDIUM FOR THE SAME

(75) Inventors: Kiyohito Yoshihara, Saitama (JP); Hironobu Higashi, Tokyo (JP); Takeshi Kouyama, Tokyo (JP); Hiroki Horiuchi, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KDDI CORPORATION, Shinjuku-ku (JP)

(21) Appl. No.: 11/611,446

(22) Filed: Dec. 15, 2006

(30) Foreign Application Priority Data
Dec. 16, 2005 (JP) P2005-363121

(51) Int. Cl. H04M 1/00; H04M 9/00

(52) U.S. Cl. 379/413.03

(57) ABSTRACT

The present invention provides an automatic setting system which can automatically or semi-automatically set a network ID into power line modems by remote operations. The present invention includes a step (S1) of detecting a request of setting a network ID into power line modems, a step (S4) of transmitting a network ID request including user ID to a user administration server on a wide area network in response to the setting request, a step (S5) of receiving a network ID reply from the user administration server, a step (S6) of storing terminal ID of the respective power line modems and a network ID included in the network ID reply for each power line modem, and a step (S10) for setting a network ID into the power line modems by transmitting the terminal ID of the respective power line modems and a network ID onto the power line network.

### BACKGROUND OF THE INVENTION

1. Field of the Invention

The present invention relates to a power line communications-enabled home terminal for automatically or semiautomatically setting a network ID in power line modems in a home power line network in which a communication line always connected to the Internet has already been introduced, an automatic setting method, program and recording medium for the same.

2. Description of the Related Art

There is known a technique for controlling data communications among PCs and information home appliances such as air conditioners and refrigerators, etc., by using a power line network forming a network by using a power line (electrical lamp line) wired in a home or building as a data transmission medium.

In such a power line network, a power line modem or a receptacle with a LAN switch function including power line modem functions (hereinafter, represented by a power line modem) is externally attached to or installed inside a terminal such as a personal computer or an information home appliance. The power line modem superimposes information received from a terminal on a power carrier wave. The superimposed information is transmitted through the power lines as a medium, separated from the power carrier wave by a power line modem installed inside or externally attached to a destination terminal and provided to the terminal.

When power line modems are used in an office or home, identifiers such as a terminal ID unique to each power line modern and a network ID unique to each user's network must be set before use. However, manual setting of identifiers is difficult for users who do not have the skills and is troublesome even for users who have the skills. Patent Documents 1 and 2 disclose techniques for automatic or semiautomatic setting of identifiers.

In Patent Document 1, a method for remotely setting a terminal ID for a power line modem via a server is disclosed. In this method, for setting a terminal ID, instead of a conventional DIP switch, a power line modem is provided with an LED, a push switch, and a buzzer.

In the case of remote setting, first, an initialization command is transmitted by broadcasting from a server to a power line modem. Next, the LED of the power line modem which received this broadcast is turned on, and when a user depresses the push switch, in this timing, the power line modem replies to the server. Finally, the server transmits a terminal ID to the power line modem from which the server could receive the reply. The power line modem that received the terminal ID writes the terminal ID on its storage device and completes setting. When a terminal ID display request is transmitted from the server to a power line modem, the buzzer of this power line modem sounds, and the user can confirm the terminal ID set in the power line modem.

Patent Documents 2 and 3 disclose techniques for remotely setting an IP address for a receptacle with a LAN switch function or a PC to be connected to the receptacle from a terminal of a system administrator. Before these techniques are developed, every time a terminal such as a PC or information home appliance is connected to a different receptacle, re-assignment of an IP address and the like is necessary, and this imposes a burden on a system administrator.

On the other hand, according to the techniques of Patent Documents 2 and 3, at the time of factory shipment, a unique address with a 64-bit length different from an IP address is assigned to a receptacle with a LAN switch function. A system administrator manually sets an IP subnet mask in a power line communication router in advance. When the receptacle with a LAN switch function is connected to the power line communication router, the power line communication router assign an IP address block corresponding to the number of receptacle ports to the receptacle with a LAN switch function. Furthermore, when a terminal such as PC or information home appliance is connected to the receptacle with a LAN switch function, the receptacle with a LAN switch function selects one IP address from the IP address block assigned from the power line communication router and assigns it to the terminal. The receptacle with a LAN switch function notifies the power line communication router of IP addresses that have been assigned to terminals up to the present. Therefore, the system administrator can collectively manage the IP addresses assigned to the respective terminals, address blocks used by respective receptacles, and IP subnet mask of the power line communication Touter by logging in the power line router.
Patent Document 1: Japanese Published Unexamined Patent Application No. 2000-295258
Patent Document 2: Japanese Published Unexamined Patent Application No. 2003-152756
Patent Document 3: Japanese Published Unexamined Patent Application No. 2003-152757

In a power line communication system, to set a network ID in power line modems, a terminal password (PW) unique to each power line modem must be inputted together with a network ID into each power line modem. However, the terminal PW is stamped on a seal or plate attached to a casing of each power line modem, so that when setting a network ID for the power line modem, a user must go to the location where each power line modem is installed and confirms the terminal PW in advance. Therefore, when a number of power line modems are installed in a network, the network ID setting and change requires enormous labor.

In the conventional technique disclosed in Patent Document 1, it is supposed that the power line modem replies to a broadcast of an unauthenticated initialization command, so that this cannot be applied to setting of a network ID. Also, in the conventional techniques disclosed in Patent Documents 2 and 3, it is not supposed that inputting of a terminal PW unique to a power line modem is required when setting a network ID in this power line modem. Therefore, in the conventional techniques, automatic or semiautomatic setting of a network ID in a power line modem is impossible.

### SUMMARY OF THE INVENTION

An object of the invention is to provide an automatic setting system which enables users to perform automatic or semiautomatic setting of a network ID into their power line modems from locations remote from the modem installed places.

In order to achieve the above-described object, the invention has the following features in a home terminal to be connected to a power line network broadband-connected to a wide area network via a power line modem, a method for automatically setting the same, and program and recording medium for the program.

(1) A home terminal of the invention is characterized in that: it includes means for transmitting a network ID request including user ID to a user administration server on a wide area network in response to a request of setting a network ID into power line modems; means for receiving a network ID reply from the user administration server; means for storing terminal ID of the respective power line modems and a network ID included in the network ID reply for each power line modem; and means fox setting a network ID into the respective power line modems by transmitting the terminal ID of the respective power line modems and the network ID onto the power line network.

(2) A method for automatically setting a home terminal according to the invention is characterized in that the method includes the steps of: detecting a request of setting a network ID into power line modems; notifying a user administration server on a wide area network of a network ID request including user ID in response to the detected setting request; receiving a network ID reply from the user administration server; storing terminal ID of the respective power line modems and a network ID included in the network ID reply for each power line modem; and setting a network ID into the respective power line modems by transmitting the terminal ID of the power line modems and the network ID onto the power line network.

(3) A program for automatically setting a home terminal according to the invention is characterized in that the program runs a computer to perform the steps of (2) described above.

(4) A recording medium for an automatic setting program according to the invention is characterized in that the medium is recorded by the program of (3) described above in a computer-readable manner.

According to the invention, terminal passwords of respective power line modems essential for setting a network ID into power line modems are collectively managed for each user ID in a server on a wide area network, and can be acquired by notifying user ID. Therefore, without self-confirmation of terminal ID (terminal password) of a power line modem and without inputting the terminal ID, a network ID can be automatically get by remote operations into a plurality of power line modems connected to a power line network, and even in a network environment in which a number of power line modems are located in a wide area, automatic setting of a network ID into the power line modems becomes possible.

### BRIEF DESCRIPTION OF THE DRAWINGS

FIG. 1 is a block diagram of a power line network to which the invention is applied;

FIG. 2 is a functional block diagram showing a construction of a user administration server and an HGW in a first embodiment of the invention;

FIG. 3 shows a sequence flow of the first embodiment of the invention;

FIG. 4 is a flowchart showing operations of the HGW in the first embodiment of the invention;

FIG. 5 is a flowchart showing operations of the user administration server in the first embodiment of the invention;

FIG. 6 is a functional block diagram showing a construction of a user administration server and an HGW in a second embodiment of the invention;

FIG. 7 shows a sequence flow of the second embodiment of the invention;

FIG. 8 is a flowchart showing operations of the HGW in the second embodiment of the invention;

FIG. 9 is a flowchart showing operations of the user administration server in the second embodiment of the invention;

FIG. 10 is a block diagram of another embodiment of a power line network to which the invention is applied;

FIG. 11 is a functional block diagram showing a construction of a user administration server and a PC in a third embodiment of the invention;

FIG. 12 is a flowchart showing operations of the PC in the third embodiment of the invention;

FIG. 13 is a diagram showing an example of a menu screen;

FIG. 14 is a diagram showing a terminal information list display example; and

FIG. 15 is a flowchart showing operations of a PC in a fourth embodiment of the invention.

### DETAILED DESCRIPTION OF THE PREFERRED EMBODIMENTS

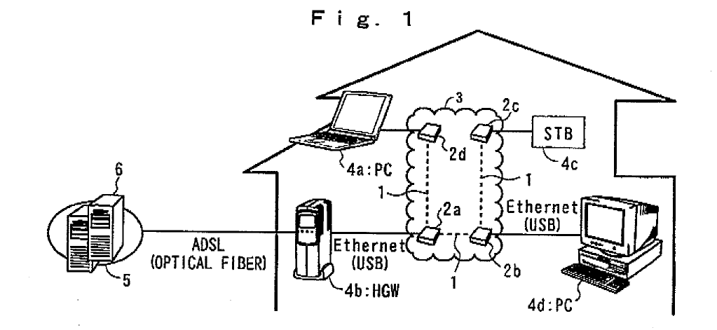

Hereinafter, best modes for carrying out the invention will be described with reference to the drawings. FIG. 1 is a block diagram showing a network composition for power line communications to which the invention is applied, and a home network in a user's home is a power line network 3 including a power line 1 and a plurality of power line moderns 2 (2a, 2b, 2c, and 2d), and home terminals such as personal computers (PCs) 4a and 4d, a home gateway (HGW) 4b, and an information home appliance (STB) 4c are connected to each power line modem 2 via Ethernet cables or USB cables. The HGW 4b is broadband-connected to a wide area network 5 of ISP via an ADSL or optical fiber, and the wide area network S has a user administration server 6 which administers user information.

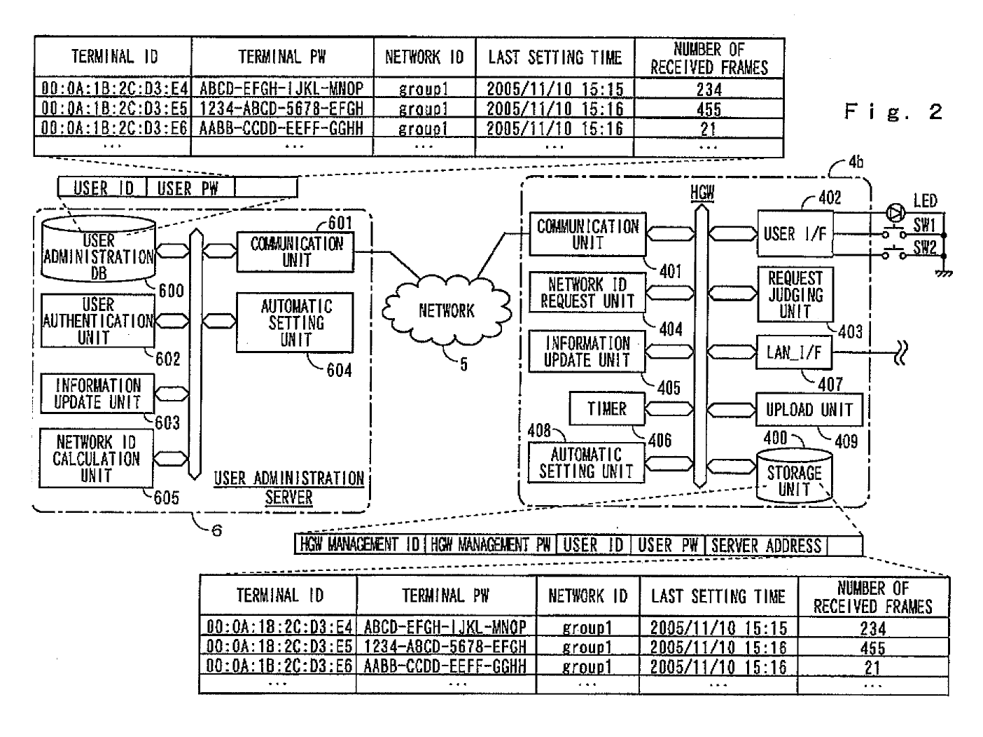

FIG. 2 is a functional block diagram showing a construction of a main part including the user administration server 6 and the HGW 4b, and construction unnecessary for the description of the invention is not illustrated.

In the user administration server 6, in user administration database (user administration DB) 600 thereof, for each pair of user ID and password (PW), as ID of all power line modems 2 provided from the ISP to the user, terminal IDs and terminal PWs are registered in advance, and furthermore, a network ID to be assigned to each power line modem 2 and “last setting time” and “number of received frames,” etc., of each power line modem 2 are registered by power line modem. The terminal ID and the terminal PW are fixed values unique to each power line modem 2, and the network ID is a variable value which the user can arbitrarily set. Therefore, before the power line modems 2 are automatically set, fixed values are registered as the terminal ID and the terminal password, and a predetermined temporary value is registered as the network ID or the network ID has not been registered yet.

A communication unit 601 communicates with the HGW 4b in each user home via the network 5. A user authentication unit 602 authenticates a user based on whether the pair of user ID and user PW received by the communication unit 601 have been registered in the user administration DB 600. An information update unit 603 updates the user administration DB 600 based on upload information periodically received by the communication unit 601. For automatically setting a network ID into the power line modems 2 of the user, an automatic setting unit 604 registers a network ID calculated by a network ID calculation unit 605 into the user administration DE 600 and transmits this network ID together with the terminal PWs to the HGW 4b via the communication unit 601. The network ID calculation unit 605 calculates a network ID unique to each user by using the user ID and the user PW as parameters and notifies the automatic setting unit 604 of this.

In the HOW 4b, in a storage unit 400, for each HGW management ID, How management PW, address of the user administration server 6, and ID and PW of each user, information such as terminal IDs and terminal PWs of the power line modems 2 and a network ID provided to the user and “the last setting time” and “number of received frames” representing an operating status are collected from the power line modems and registered for each power line modem. However, since starting of the flow 4b until the end of setting of the power line modems 2, information including the terminal IDs, terminal PWs, a network ID, “the last setting time,” and “number of received frames” are not registered.

The communication unit 401 communicates with the user administration server 6 via the network 5. To a user interface (I/F) 402, two setting switches SW1 and SW2 and one two-color illuminator LED are connected. A request judging unit 403 judges a request from a user based on the details of operations on the switches SW1 and SW2. A network ID request unit 404 requests assignment of a network ID to each power line modem 2 by transmitting a network ID request including a user ID and a user PW to the user administration server 6. The information updates unit 405 updates the details of registration in the storage unit 400 based on a network ID reply replied from the user administration server 6 in response to the network ID request. A timer 406 counts a predetermined elapsed time or period. To a LAN interface (I/F) 407, power line modems 2 are connected via Ethernet (registered trademark>cables or USB cables. An automatic setting unit 408 automatically sets a network ID by transmitting a pair of terminal PW and network ID to a power line modem 2 as an object to be automatically set. An upload unit 409 periodically uploads terminal ID stored in the storage unit 400 and operating statuses collected from the power line modems 2 to the user administration server 6.

The constructions in the HGW 4b are realized not only by hardware but also by an automatic setting program described later. This automatic setting program is preinstalled by a manufacturer of the HGW 4b, automatically downloaded from the user administration server 6 when the HGW 4b is connected for the first time to the network 5, or installed by using a PC from a program recording medium such as a CD-ROM.

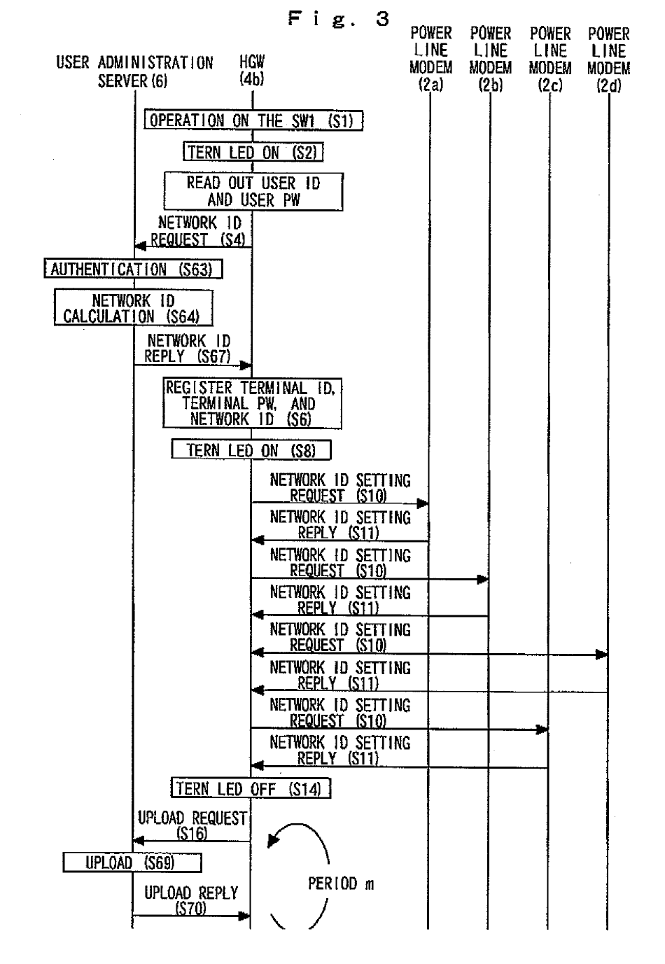

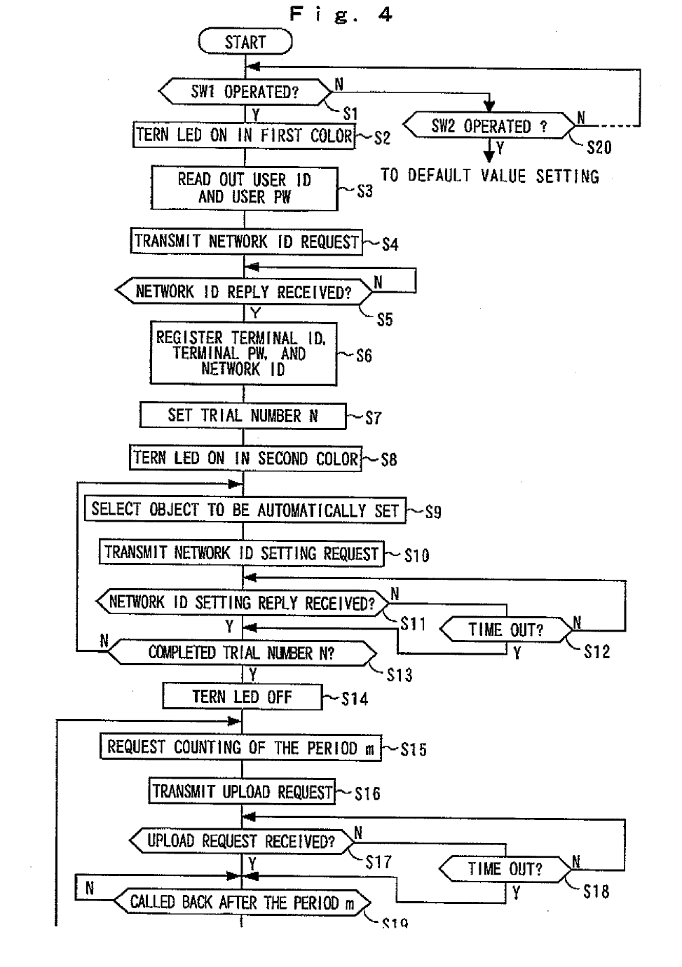

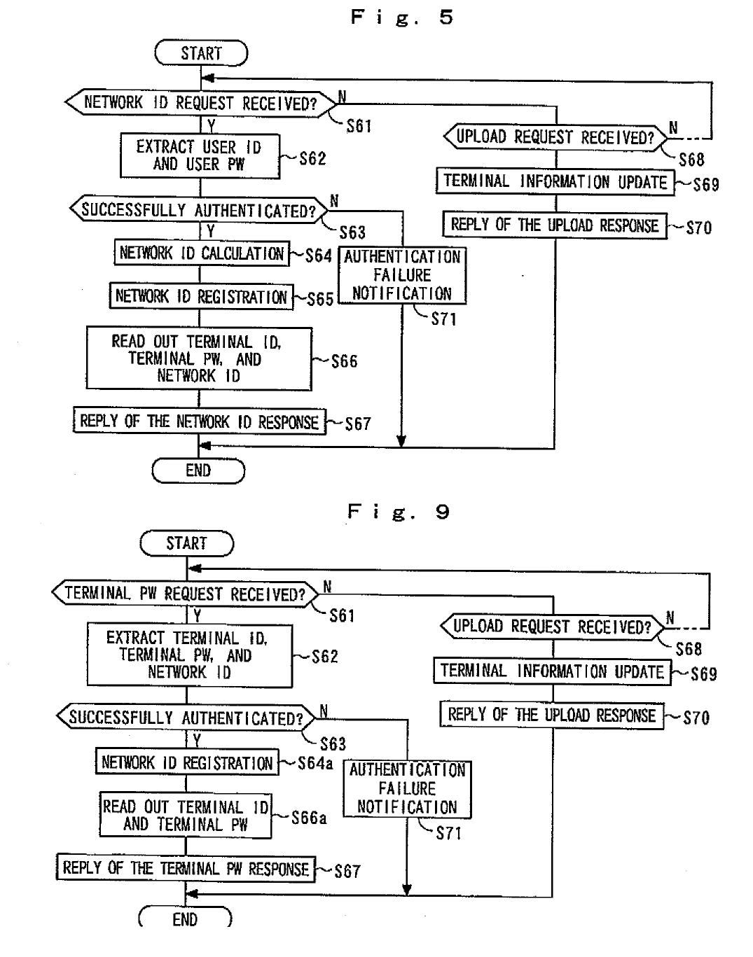

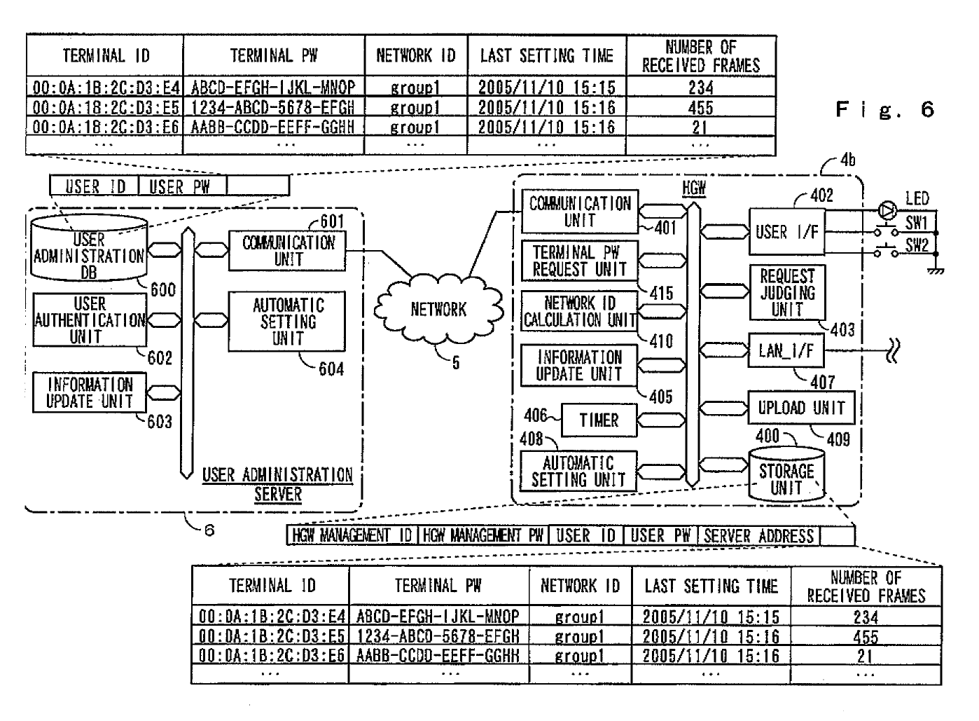

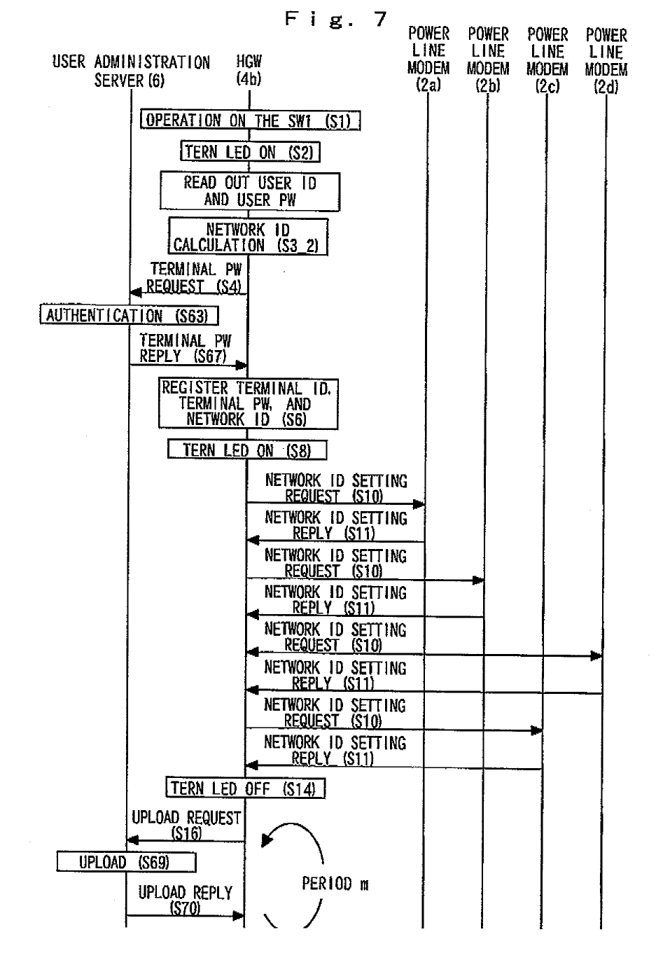

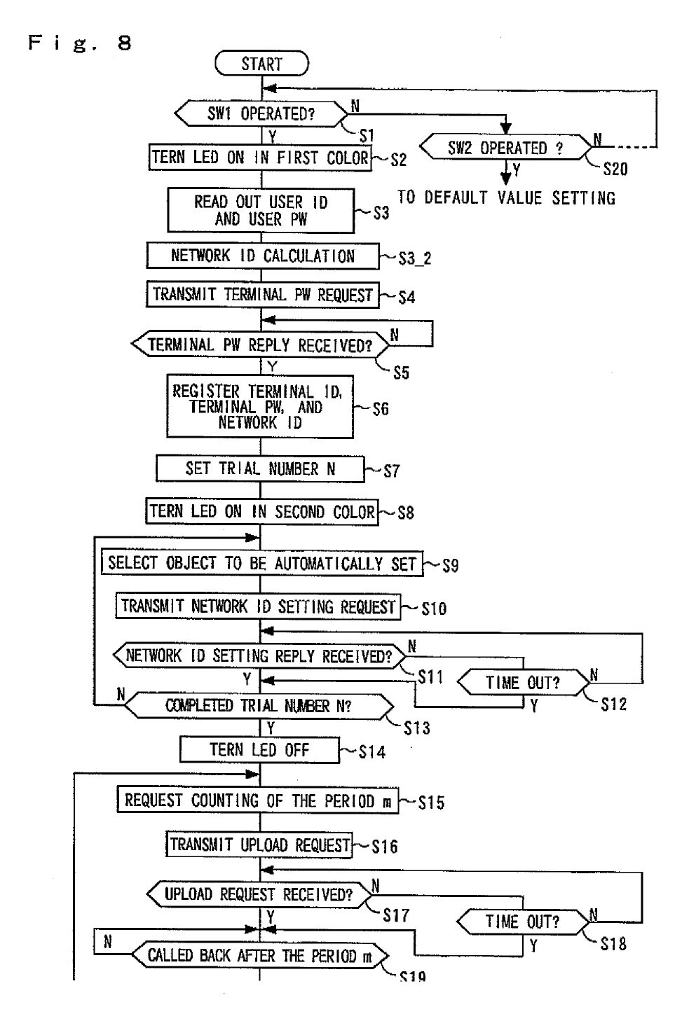

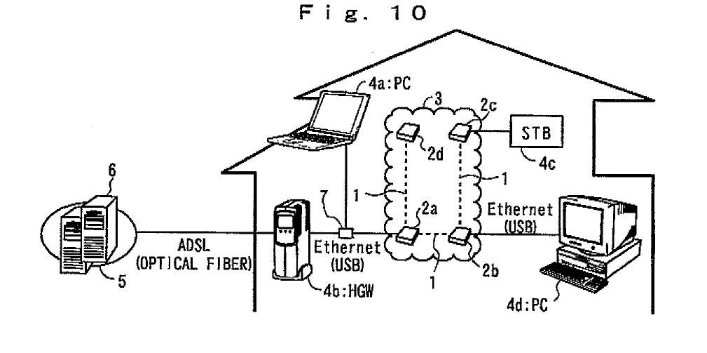

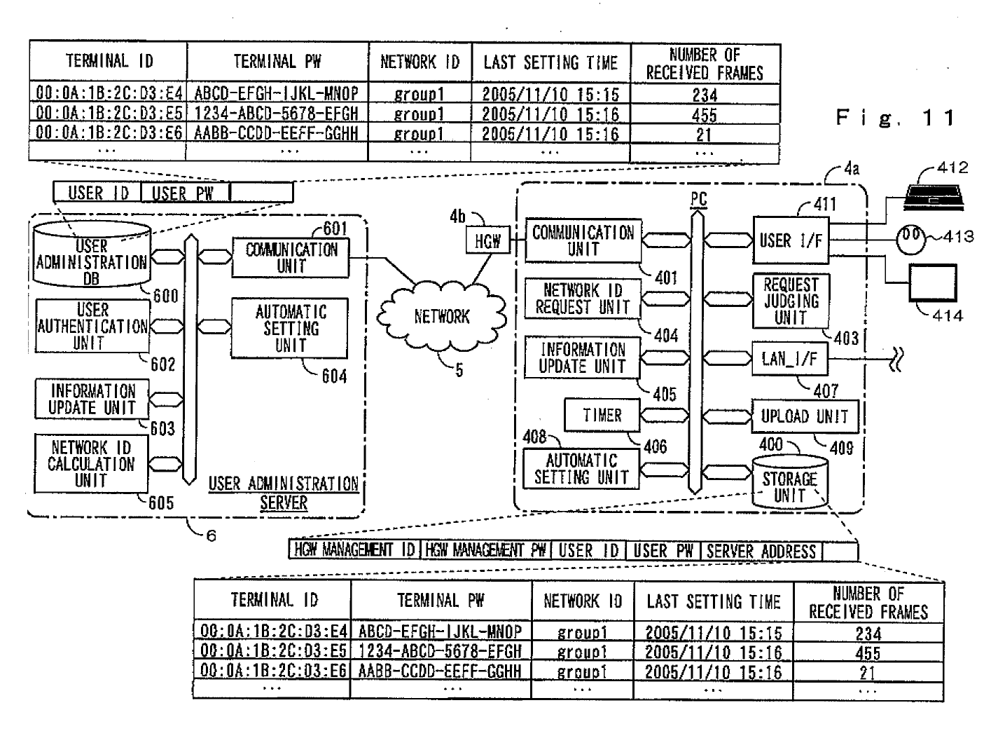

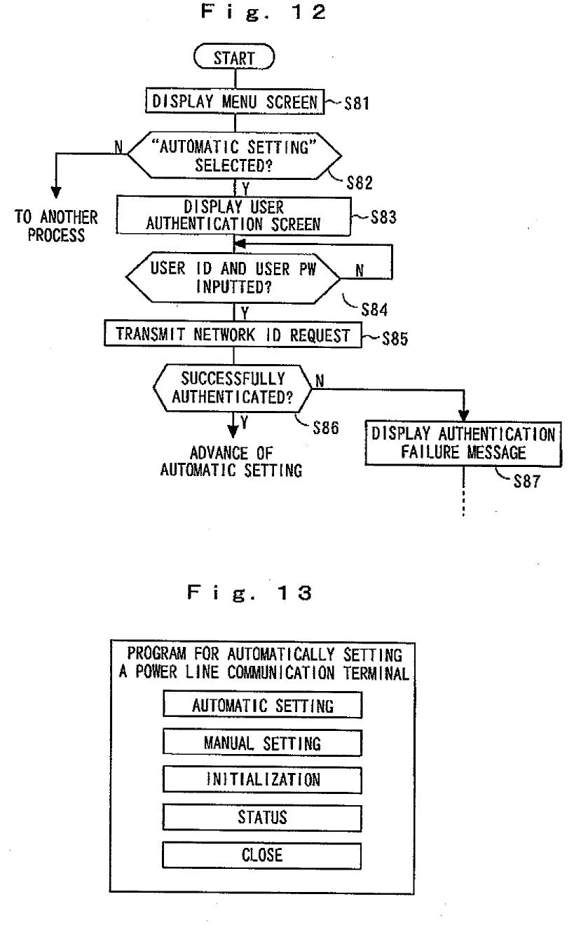

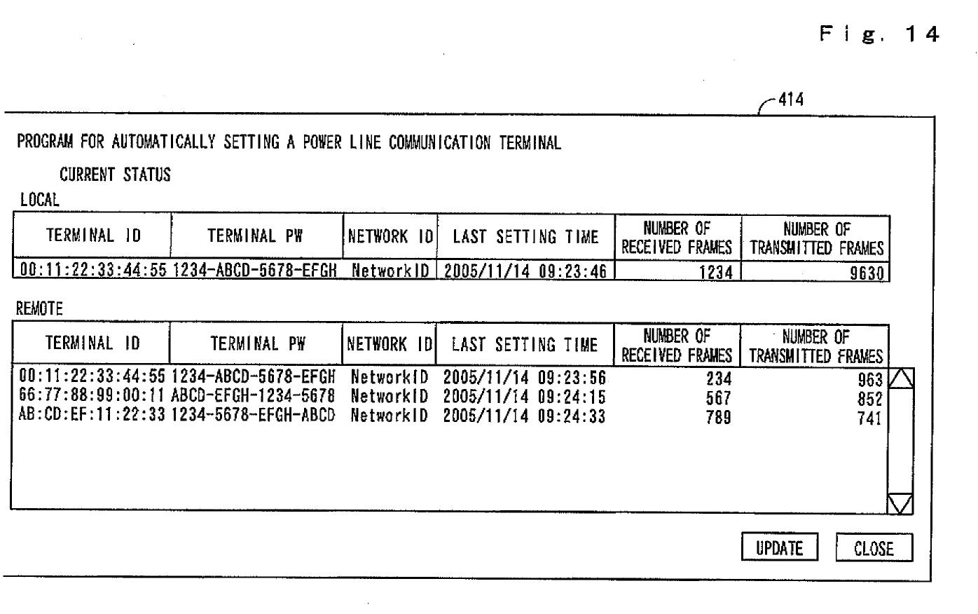

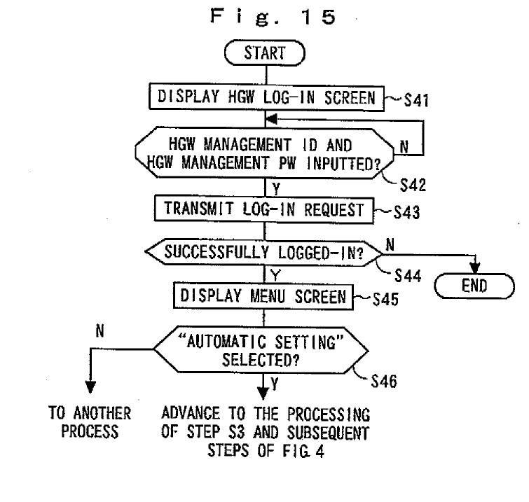

Next, operations of the first embodiment for automatically setting a network ID into each power line modem 2 will be described with reference to the sequence flow of FIG. 3 and the flowcharts of FIG. 4 and FIG. 5. In this embodiment, it is assumed that the automatic setting program has been downloaded in advance by a user or preinstalled in the HGW 4b, and the user directly operates the HGW 4b to automatically set a network ID into each power line modem 2.

FIG. 4 is a flowchart showing operations of the HGW 4b, and at step S1, when the switch SW1 (automatic setting button) is depressed by a user who requests automatic setting of the power line modems 2 and this is detected by the user IF 402, at step S2, the request judging unit 403 judges this as an automatic setting request, and the LED is turned on in a first color (for example, red). At Step S3, a user ID and a user Pw registered in advance in the storage unit 400 are readout by the network ID request unit 404. At step S4, to acquire a terminal PW necessary for setting a network ID into the power line modem 2 from the user administration server 6, a network ID request including the readout user ID and user PW is generated in the network ID request unit 404 and transmitted from the communication unit 401 to the user administration server 6.

FIG. 5 is a flowchart showing operations of the user administration server 6, and at Step S61, when the network ID request is received by the communication unit 601, at Step 62, the user ID and the user PW included in this network ED request are extracted. At Step S63, in the user authentication unit 602, the user is authenticated based on whether the extracted user ID and user PW have been registered in the user administration DE 600. When the user is successfully authenticated, the process advances to Step S64, and a network ID is calculated by the network ID calculation unit 605. In this embodiment, the network ID is calculated by substituting the user ID and the user PW for predetermined functions. At Step S65, the network ID is registered in the user administration DB 600. when the authentication is failed at Step S63, the process advances to Step S71 and authentication failure notification is replied.

At Step 566, a terminal ID, a terminal PW, and a network ID made correspondent to the pair of user ID and user PW are readout from the user administration DB 600. A plurality of terminal IDs, terminal PWs, and a network ID are registered, all of these are readout. At Step S67, a network ID reply including the terminal IDs, the terminal PWs, and the network ID is replied from the communication unit 601 to the HGW 4b.

Returning to FIG. 4, in the HGW 4b, when the network ID reply is received at Step S5, at Step S6, the terminal IDs, the terminal PWs, and the network ID included in the network ID reply are extracted by the information update unit 405 and registered in the storage unit 400. At Step S7, the number of automatic setting trials n is set. This number of trials n is set to, for example, a value obtained by multiplying the number of pairs of terminal ID (terminal ID and terminal password) acquired from the user administration server 6, that is, the number of power line modems n1 by a predetermined number of repetitions n2 (n1×n2).

At Step SS, for informing the user of the start of automatic setting, the luminescence color of the LED is changed to a second color (for example, green). When the luminescence color of the LED changes from the first color to the second color, the user recognizes that the automatic setting of a network In) is to be executed into a power line modem 2 attached to the receptacle.

At Step S9, when terminal information of a plurality of power line moderns are included in the network ID reply, a power line modem as a current object to be automatically set is selected in ascending order of the terminal IDs. At Step S10, by the automatic setting unit 408, a network ID setting request including a pair of terminal PW and network ID of this power line modem is transmitted to this power line modern as a current object to be automatically set, and a reply period timer starts. The network ID setting request is encoded according to an appropriate cipher system such as 56-bit DES. The power line modem 2 that has received the network ID setting request compares a terminal PW included in this setting request with its own terminal PW, and when these match with each other, the power line modem sets the network ID as itself and sends a reply of a network ID setting reply to the HGW 4b.

In HGW 4b, at Step S11, it is judged whether the network ID setting reply has been replied from the power line modem as an object to be automatically set . When the network ID setting reply is replied or time out of the reply period timer is detected at Step S12 before the network ID setting reply is replied, the process advances to Step S13. At Step S13, it is judged whether automatic setting has been repeated the number of trials n. When the number of trials n is not reached, the process returns to Step S9 and repeats the above-described processing, and network ID automatic setting is tried for all power line modems 2 included in the network ID reply replied from the user administration server 6.

For automatically setting a network 1D into the power line modems 2, it is necessary that the network ID has already been set in the power line modem 2 directly connected to the home terminal 4 (in this embodiment, HGW 4b) in which the automatic setting program is installed. Therefore, in the case of the network composition shown in FIG. 1, unless the setting of the power line modem 2a is completed, other power line modems 2b, 2c, and 2d cannot be autocratically. Therefore, before automatic setting of the power line modem 2a, even if the power line modem 2c is selected as an object to be automatically set, automatic setting of this is impossible. However, in this embodiment, automatic setting is repeatedly tried within the number of trials n for the power line modem before being automatically set, so that after automatic setting of the power line modem 2a, the power line modem 2c is also automatically set.

Thereafter, when the number of trials reaches n at Step S13, the LED is turned off to inform the user of completion of the automatic setting at Step S14. At Step S15, for periodically updating user information for the purpose of user support by an ISP staff, a schedule for call-back after elapse of a predetermined period m is set in the timer 406. At Step S16, an upload request including a terminal ID, a terminal PW, a network ID, “last setting time,” and “number of received frames,” etc., is transmitted to the user administration server 6 from the upload unit 409 via the communication unit 401, and the reply period timer starts.

Returning to FIG. 5, when the user administration server 6 receives the upload request at Step S68, at Step S69, information included in the upload request is update-registered in the user administration DE by the information update unit 603. At Step S70, an upload reply is replied to the HGW 4b via the communication unit 601.

Returning to FIG. 4, in the HGW 4b, it is judged whether the upload reply has been replied at Step S17. When the upload reply is replied or time out of the reply period timer is detected at Step S18 before the upload reply is replied, the process advances to Step S19. At Step S19, the process waits until a call back after the period m is detected, and when the call back is detected, the process returns to Step S15 and repeats the above-described processing. Namely, the uploading to the user administration server 6 is repeated in a cycle of a period m.

On the other hand, when an operation on the SW 1 is not detected at Step S1 and an operation on the SW 2 is detected at Step S20, default value setting is executed for setting a fixed value such as a predetermined default value as a network ID into each power line modem 2. In this default value setting, from the HGW 4b to the user administration server 6, a default value setting request is transmitted instead of the network ID request (Step S4). From the user administration server 6, in response to this default value setting request, a default value setting reply including a terminal ID, a terminal PW, and a default value is replied instead of the network ID reply (Step S5) The HGW 4b sets the default value as a network ID into all power line modems 2 based on the received terminal ID, terminal PW, and default value, similar to the case of the network ID setting.

In the above-described embodiment, it is described that network ID automatic setting is started in response to an operation made by a user on the SW1 or SW2 of the HGW 4b, however, it is also possible that the automatic setting is started when a predetermined time elapses after installation of the automatic setting program.

FIG. 6 is a functional block diagram showing a construction of the main part of a user administration server 6 and a HGW 4b in a second embodiment of the invention, and the same reference numerals as described above denote the same or equivalent portions.

In the above-described embodiment, the user administration server 6 is provided with the network ID calculation unit 605, and calculates a network ID based on a user ID and a user PW received from the HGW 4b and notifies the HGW 4b of the result of calculation. On the other hand, in the second embodiment, the HGW 4b is provided with the terminal PW request unit 415 and the network ID calculation unit 410, and acquires only a terminal PW from the user administration server 6 and calculates a network ID by itself based on a user ID and a user PW registered in the storage unit 400.

Next, operations of the second embodiment for automatically setting a network ID into the respective power line modems 2 are described along the sequence flow of FIG. 7 and the flowcharts of FIG. 8 and FIG. 9. Also, in this embodiment, the automatic setting program is downloaded by the user or preinstalled into the HGW 4b in advance.

FIG. 8 is a flowchart showing operations of the HGW 4b, and at Step S1, the switch SW1 (automatic setting button) is depressed, and when this is detected by the user I/F 402, at Step S2 it is judged as an automatic setting request by the request judging unit 403, and the LED is turned on in the first color (for example, red). At Step S3, a user ID and a user PW registered in advance in the storage unit 400 are readout by the network ID request unit 404. At Step S3_2, by the network ID calculation unit 410, a network ID unique to the user is calculated based on the readout user ID and user PW.

At Step S4, for acquiring a terminal PW necessary for setting the network ID into the power line modem 2 from the user administration server 6, a terminal PW request including the user ID, the user PW, and a network ID is generated in the terminal PW request unit 415 and transmitted from the communication unit 401 to the user administration server 6.

FIG. 9 is a flowchart showing operations of the user administration server 6, and at Step S61, when the terminal PW request is received by the communication unit 601, at Step S62, the user ID, the user PW, and the network ID included in the terminal PW request are extracted. At Step S63, in the user authentication unit 602, the user is authenticated based on whether the extracted pair of user ID and user PW has been registered in the user administration DB 600. When the user is successfully authenticated, the process advances to Step S64a, and the extracted network ID is registered in the user administration DB 600.

At Step 66a, a terminal ID and a terminal PW made correspondent to the pair of user ID and user PW are readout from the user administration DE 600. When a plurality of pairs of terminal IDs and terminal PWs are registered, all of these are readout. At Step S67, a terminal PW reply including the terminal ID and terminal PW is replied from the communication unit 601 to the HGW 4b.

Returning to FIG. 8, in the HGW 4b, when the terminal PW reply is received at Step S5, at Step S6, the terminal ID and terminal PW included in this terminal PW reply are registered in the storage unit 400 together with the network ID by the information update unit 405. At Step S7, the number of trials n is set. At Step S8, for informing the user of the start of automatic setting, the luminescence color of the LED is changed to the second color (for example, green).

At Step S9, in the case where terminal information of a plurality of power line modems are included in the terminal PW reply, a power line modem as a current object to be automatically set is selected, for example, in ascending order of the terminal IDs. At Step S10, by the automatic setting unit 408, a network ID setting request including the pair of terminal PW and network ID is transmitted to the power line modem as a current object to be automatically set, and the reply period timer starts. The power line modem 2 which received this network ID setting request compares the terminal PW included in this setting request with its own PW, and when these match with each other, the power line modem sets the network ID as itself and sends a reply of a network ID setting reply to the HGW 4b.

In the HGW 4b, at Step S11, it is judged whether the network ID setting reply has been replied from the power line modem as an object to be automatically set. When the network ID settings reply is replied or time out of the reply period timer is detected at Step S12 before the network ID setting reply is replied, the process advances to Step S13 At Step S13, the process returns to Step S9 and repeats the above-described processing until the number of trials n is reached, and it is tried to automatically set all of the power line modems 2 included in the terminal PW reply replied from the user administration server 6.

At Step S13, when completion of the number of trials n is detected, the LED is turned off and the user is informed of the completion of automatic setting at Step S14. At Step S15, a schedule for call-back after elapse of a predetermined period m is set in the timer 406. At Step S16, an upload request including the terminal ID, the terminal PW, the network ID, “Last setting time,” and “number of received frames,” etc., is transmitted from the upload unit 409 to the user administration server 6 via the communication unit 401 and the reply period timer starts.

Returning to FIG. 9, when the user administration server 6 receives the upload request at Step S68, at Step S69, terminal information included in this upload request is update-registered in the user administration DB by the information update unit 603. At Step S70, an upload reply is replied to the HGW 4b via the communication unit 601.

Returning to FIG. 8, in the HGW 4b, it is judged whether the upload reply has been replied at Step S17. when the upload reply is replied or time out of the reply period timer is detected at Step S18 before the upload reply is replied, the process advances to Step S19. At Step S19, the process waits until call back after the period m is detected, and when a call back is detected, the process returns to Step S15 and repeats the above-described processing.

FIG. 10 is a block diagram preferable for another embodiment of power line communications to which the invention is applied. In the above-described embodiments, an automatic setting program is installed in advance in the HGW 4b, and a user directly operates the HGW 4b to automatically set a network ID into each power line modem 2.

On the other hand, in this embodiment, a PC 4a is connected to the LAN_I/F 407 of the HGW 4b via a hub 7. The automatic setting program is installed in advance in the PC 4a, and a user operates the PC 4a to automatically set the power line modems 2 (third embodiment), or executes the automatic setting program installed in the HGW 4b from the PC 4a by remote operations.

FIG. 11 is a functional block diagram showing a main part of the user administration server 6 and the PC 4a in the third embodiment in which an automatic setting program is installed in advance in the PC 4a, and the same reference numerals as described above denotes the same or equivalent portions. In this embodiment, to the user interface (I/F) 411 of the PC 4a, a keyboard 412, a mouse 413, and a display 414 are connected.

FIG. 12 is a flowchart showing operations of the PC in this embodiment. The automatic setting program is provided in advance to the user by being stored in a recording medium such as a CD-ROM and installed in advance in the PC, or is resident in the PC by being downloaded through a network. When the operating system (OS) of the PC is the Windows™ XP, an icon is displayed in the task tray on the lower right of the screen of the display 414.

When the icon of the automatic setting program is double-clicked, at Step S81, a menu screen as exemplified in FIG. 13 is displayed on the display 414. At Step S82, the user operates the keyboard 412 or the mouse 413 to select “automatic setting,” and when this is detected, the process advances to Step S83. When “current status” is selected at Step S82, the contents stored in the storage unit 400 are displayed as a list on the display 414 as in an example shown in FIG. 14.

At Step S83, a user authentication screen is displayed on the display 414. When a user ID and a user PW are inputted through the keyboard 412 at Step S84 and this is detected, at Step S85, a network ID request including the inputted user ID and user PW is transmitted to the user administration server 6 similar to Step S4 of the first embodiment described above with reference to FIG. 4.

In the user administration server 6, similar to the first embodiment, the user is authenticated based on whether the pair of received user ID and user PW has already been registered in the user administration DB 600. At Step S86, when an authentication failure is detected, a message indicating the authentication failure is displayed on the display 414 at Step S87. When the user is successfully authenticated and a network ID reply is replied from the user administration server 6, after this, automatic setting progresses according to the same procedures as Step S5 and subsequent steps of FIG. 4.

FIG. 15 is a flowchart of operations of the PC 4a in a fourth embodiment in which a user remotely executes the automatic setting program installed in the HGW 4b from the PC 4a.

At Step S41, an HGW login screen is displayed on the display, and when a user inputs an HGW management ID and an MGW management PW at Step S42, the process advances to Step S43 At Step S43, a log-in request including the HGW management ID and the HGW management PW is transmitted to the HGW 4b. In the HGW 4b, authentication is performed based on whether the pair of HGW management ID and HGW management PW included in the received log-in request has been registered in the storage unit 400, and the HGW 4b sends a reply of a log-in reply including the result of authentication to the PC 4a.

When the PC 4a receives the log-in reply at Step S44 and detects that it has successfully logged-in, at Step S45, a menu screen exemplified in FIG. 12 is displayed on the display. At Step S46, when the selection of “automatic setting” is detected, after this, the process advances to Step S3 and subsequent steps of FIG. 4.

In the above-described embodiments, when network ID automatic setting is requested, the automatic setting program transmits a network ID request and a terminal PW request to the user administration server 6 to request a network ID and a terminal PW each time the request arises, however, it is also possible that the automatic setting program stores the acquired network ID and terminal PW as appropriate and, for the second automatic setting request, automatic setting is performed without inquiring the user administration server 6 about these.

Furthermore, in the above-described embodiments, it is assumed that a power line communication terminal in which a network ID is to be automatically set is a power line modem, however, other than the power line modem, the invention is also applicable to power line communication terminals such as a receptacle with a LAN switch function provided with a power line modem function.

What is claimed is:

1. A power line communication-enabled home terminal to be connected, via power line modems, to a power line network which is broadband-connected to a wide area network, comprising:
means for transmitting a network ID request including user ID to a user administration server on a wide area network in response to a request of setting a network ID into respective power line modems;
means for receiving a network ID reply from the user administration server;
means for storing terminal ID of the respective power line modems and a network ID included in the network ID reply for each power line modem; and
means for setting a network ID into the respective power line modems by transmitting the terminal ID of the power line modems and the network ID onto the power line network.

2. A power line communication-enabled home terminal to be connected, via power line modems, to a power line network which is broadband-connected to a wide area network, comprising:
means for transmitting a terminal ID request including user ID to a user administration server on a wide area network in response to a request of setting a network ID into respective power line modems;
means for receiving a terminal ID reply from the user administration server;
means for storing terminal ID of the respective power line modems included in the terminal ID reply for each power line modem;
means for generating a network ID; and
means for setting a network ID into the respective power line modems by transmitting the terminal ID of the power line modems and the network ID onto the power line network.

3. A power line communication-enabled home according to claim 1, further comprises:
means for collecting operating statuses of the respective power line modems; and
means for uploading the operating statuses of the respective power line modems to a user administration server by making these correspondent to their ID.

4. The power line communication-enabled home terminal according to claim 1, wherein the home terminal has a function as a home gateway.

5. The power line communication-enabled home terminal according to claim 1, wherein the home terminal has a function as a personal computer.

6. A method for automatically setting a network ID into power line modems of a power line network to be broadband-connected to a wide area network, comprising the steps of:
detecting a request of setting a network ID into power line modems;
transmitting a network ID request including user ID to a user administration server on a wide area network in response to the setting request;
receiving a network ID reply from the user administration server;
storing terminal ID of power line modems included in the terminal ID reply and network ID for each power line modem; and
setting a network ID into the power line modems by transmitting the terminal ID of the power line modems and the network ID onto the power line network.

7. A method for automatically setting a network ID into power line modems of a power line network to be broadband-connected to a wide area network, comprising the steps of:
detecting a request of setting a network ID into power line modems;
transmitting a terminal ID request including user ID to a user administration server on a wide area network in response to the setting request;
receiving a terminal ID reply from the user administration server;
storing terminal ID of power line modems included in the terminal ID reply for each power line modem;
generating a network ID; and
setting a network ID into the power line modems by transmitting the terminal ID of the power line modems and the network ID onto the power line network.

8. A method for automatically setting a network ID into power line modems according to claim 6, further comprising the steps of;
collecting operating statuses of the respective power line modems; and
uploading the operating statuses of the respective power line modems to a user administration server by making these correspondent to their ID.

9. A program for automatically setting a network ID into power line modems of a power line network to be broadband-connected to a wide area network, wherein
the program makes a home terminal connected to a power line network via the power line modems to execute the steps of:
detecting a request of setting a network ID into the power line modems;
notifying a user administration server on a wide area network of a network ID request including user ID in response to the setting request;
receiving a network ID reply from the user administration server;
storing terminal ID of respective power line modems and a network ID included in the network ID reply for each power line modem; and
setting a network ID into power line modems by transmitting the terminal ID of the respective power line modems and a network ID onto the power line network.

10. A program for automatically setting a network ID into power line modems of a power line network to be broadband-connected to a wide area network, wherein
the program makes a home terminal connected to a power line network via the power line modems to execute the steps of:
detecting a request of setting a network ID into the power line modems;
notifying a user administration server on a wide area network of a terminal ID request including user ID in response to the setting request;
receiving a terminal ID reply from the user administration server;
storing terminal ID of respective power line modems included in the terminal ID reply for each power line modem;
generating a network ID; and
setting a network ID into power line modems by transmitting the terminal ID of the respective power line modems and a network ID onto the power line network.

11. A program for automatically setting a network ID into power line modems of a power line network according to claim 9, further comprising the steps of:
collecting operating statuses of the respective power line modems; and
uploading the operating statuses of the respective power line modems to a user administration server by making these correspondent to their ID.

12. A computer-readable recording medium recording a program for automatically setting a network ID into power line modems of a power line network to be broadband-connected to a wide area network, wherein
the program makes a computer to be connected to a power line network via the power line modems to execute the steps of:
detecting a request of setting a network ID into the power line modems;
notifying a user administration server on a wide area network of a network ID request including user ID in response to the detected setting request;
receiving a network ID reply from the user administration server;
storing terminal ID of respective power line modems and a network ID included in the network ID reply for each power line modem, and
setting a network ID into power line modems by transmitting the terminal ID of the respective power line modems and a network ID onto the power line network.

13. A computer-readable recording medium recording a program for automatically setting a network ID into power line modems of a power line network to be broadband-connected to a wide area network, wherein
the program makes a computer to be connected to a power line network via the power line modems to execute the steps of;
detecting a request of setting a network ID into the power line modems,
notifying a user administration server on a wide area network of a terminal ID request including user ID in response to the detected setting request;
receiving a terminal ID reply from the user administration server;
storing terminal ID of respective power line modems in the terminal ID reply for each power line modem;
generating a network ID; and
setting a network ID into power line modems by transmitting the terminal ID of the respective power line modems and a network ID onto the power line network.

14. The computer-readable recording medium recording a program according to claims 12 and 13, wherein the program makes the computer to further execute the steps of:
collecting operating statuses of the respective power line modems; and
uploading the operating statuses of the respective power line modems to a user administration server by making these correspondent to their ID.
